(19) United States
(12) Patent Application Publication
(10) Pub. No.: US 2006/0257555 A1
(43) Pub. Date: Nov. 16, 2006

(54) Sub-layer for adhesion promotion of fuel cell bipolar plate coatings

(76) Inventors: Brian K. Brady, North Chili, NY (US); Timothy J. Fuller, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/127,552

(22) Filed: May 12, 2005

(51) Int. Cl. B05D 5/12

(52) U.S. Cl. 427/115

(57) ABSTRACT

The present invention provides an electrically conductive element for an electrochemical cell element having enhanced protection for an underlying metal substrate with a surface susceptible to forming metal oxides. One or more regions of the surface are coated with an adhesion promoting coating comprising a silicon containing material derived from organosilanes. The adhesion promoting coating is overlaid with a conductive, protective polymeric coating. The present invention further provides methods of making such an electrochemical cell element to have improved adhesion of conductive, protective polymer coatings.

### FIELD OF THE INVENTION

The present invention relates to PEM fuel cells and more particularly to corrosion-resistant electrically conductive elements therefor.

### BACKGROUND OF THE INVENTION

Fuel cells have been proposed as a power source for electric vehicles and other applications. One known fuel cell is the PEM (i.e., Proton Exchange Membrane) fuel cell that includes a so-called MEA (“membrane-electrode-assembly”) comprising a thin, solid polymer membrane-electrolyte having an anode on one face and a cathode on the opposite face. The anode and cathode typically comprise finely divided carbon particles, very finely divided catalytic particles supported on the internal and external surfaces of the carbon particles, and proton conductive material intermingled with the catalytic and carbon particles. The MEA is sandwiched between a pair of electrically conductive contact elements which serve as current collectors for the anode and cathode, which may contain appropriate channels and openings therein for distributing the fuel cell's gaseous reactants (i.e., H₂ and O₂/air) over the surfaces of the respective anode and cathode.

Bipolar PEM fuel cells comprise a plurality of the MEAs stacked together in electrical series while being separated one from the next by an impermeable, electrically conductive contact element known as a bipolar plate or septum. The bipolar plate has two working surfaces, one confronting the anode of one cell and the other confronting the cathode on the next adjacent cell in the stack. The bipolar plate conducts electrical current between the adjacent cells. Contact elements at the ends of the stack contact only the end cells and are referred to as end plates.

Contact elements are often constructed from electrically conductive metal materials. In an H₂ and O₂/air PEM fuel cell environment, the bipolar plates and other contact elements (e.g., end plates) are in constant contact with highly acidic solutions (pH 3-5) and operate in a highly oxidizing environment, being polarized to a maximum of about +1 V (vs. the normal hydrogen electrode). On the cathode side the contact elements are exposed to pressurized air, and on the anode side exposed to super atmospheric hydrogen. Unfortunately, many metals are susceptible to corrosion in the hostile PEM fuel cell environment, and some also form highly electrically resistive, passivating oxide films on their surface (e.g., in the case of titanium, stainless steel, nickel, magnesium, aluminum or alloys) that increases the internal resistance of the fuel cell and reduces its performance.

In light of the corrosion sensitivity of these metals, efforts have been made to develop conductive polymeric protective coatings. One effort includes protective polymeric coatings that have a lessened impact on electrical resistance and maintain an acceptable level of conductivity, however these coatings have the potential to peel or chip due to the potential reduction of coating adhesion while the element is exposed to the humidified, high temperature and pressure of a working fuel cell. Coating detachment could potentially expose the underlying metal substrate to corrosion and/or decreased conductivity.

Accordingly, there is a need for an increased adhesion of protective polymeric, protective, and electrically conductive coatings to a substrate while maintaining electrical conductivity, to resist the fuel cell's hostile environment and to improve the overall efficiency and longevity of the electrochemical cell.

### SUMMARY OF THE INVENTION

The present invention provides an electrically conductive element for an electrochemical cell comprising an electrically conductive substrate having a surface susceptible to corrosion. The surface has one or more regions overlaid with an adhesion promoting coating, where the coating comprises a polymer comprising silicon. In certain embodiments, the silicon is a siloxane moiety derived from a hydrolyzed organosilane. The adhesion promoting coating is overlaid with an electrically conductive corrosion resistant coating at the one or more regions, where the corrosion resistant coating comprises a polymer.

In another aspect, the present invention provides an electrically conductive metallic substrate having a surface susceptible to forming oxides in the presence of oxygen comprising an adhesion promoting coating overlying a region of the surface, where the coating comprises silicon. An electrically conductive protective polymeric coating overlies the adhesion promoting coating. The adhesion promoting coating improves the adhesion of the polymeric coating and the metallic substrate when compared to an adhesion of an electrically conductive protective polymeric coating overlying the metallic substrate, in the absence of the adhesion promoting coating.

In yet another aspect, the present invention relates to a method of making an element for a fuel cell, comprising applying an adhesion promoting coating comprising a silicon containing polymer to one or more regions of a surface of a substrate, and overlaying the adhesion promoting coating with a corrosion resistant coating overlying at the one or more regions.

The present invention also relates to a method of preparing a coating to promote adhesion between a metal substrate and a corrosion-resistant polymer coating for use in an electrochemical cell, the method comprising mixing a hydrolyzing agent into a solution comprising a functionalized silane and a solvent comprising water, wherein the hydrolyzing agent serves to hydrolyze the functionalized silane to promote adhesion of the silane with the respective metal substrate and corrosion resistant polymer coating.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of two cells in a liquid-cooled PEM fuel cell stack;

FIG. 2 is an exploded, isometric view of a bipolar plate useful with PEM fuel cell stacks like that illustrated in FIG. 1;

FIG. 3 is a sectioned view in the direction 3-3′ of FIG. 2;

FIG. 4 is a magnified portion of the bipolar plate of FIG. 3 showing a preferred embodiment of the present invention showing a coating of metal oxides layer, a silane adhesion promoting coating and a protective polymeric coating;

FIG. 5 is a partial cross-sectional view of a working surface of a preferred embodiment of the present invention showing a substrate having a continuous region coated with an adhesion promoting coating and a conductive protective polymeric coating;

FIG. 6 is a partial cross-sectional view of a working surface of another preferred embodiment of the present invention showing a substrate having a continuous region coated with an adhesion promoting coating overlaid with a protective polymeric coating having conductive regions and non-conductive regions;

FIG. 7 is a partial cross-sectional view of a working surface of another preferred embodiment of the present invention showing a plurality of lands and grooves formed in the surface of a substrate, where the regions corresponding to the grooves are coated with an adhesion promoting coating overlaid with a protective polymeric coating, and the lands are coated with an electrically conductive layer;

FIG. 8 is a partial cross-sectional view of a working surface of an alternate preferred embodiment of the present invention showing a substrate having a plurality of lands and grooves formed therein, where the metal oxides are removed in the regions corresponding to the lands of the surface and the metal oxides remain in the regions corresponding to the grooves, where both the lands and grooves further have a continuous region coated with an adhesion promoting coating and a conductive protective polymeric coating; and

FIG. 9 is a partial cross-sectional view of a working surface of a preferred embodiment of the present invention where a plurality of lands and grooves are formed in the surface and the lands are overlaid with a protective polymeric coating and the grooves are overlaid with an adhesion promoting coating and a protective polymeric coating.

### DETAILED DESCRIPTION OF THE PREFERRED EMBODIMENTS

The following description of the preferred embodiment(s) is merely exemplary in nature and is in no way intended to limit the invention, its application, or uses.

The present invention relates to an electrically conductive element in an electrochemical cell. The conductive element comprises a metal substrate with a surface susceptible to forming metal oxides in the presence of oxygen, which has one or more regions preferably coated with a silane adhesion promoting coating, or sub-layer, according to the present invention. The adhesion promoting coating sub-layer serves to increase adhesion of an overlaid electrically conductive corrosion-resistant polymeric protective coating to the substrate surface, thereby enhancing protection of the substrate from the corrosive environment of the fuel cell.

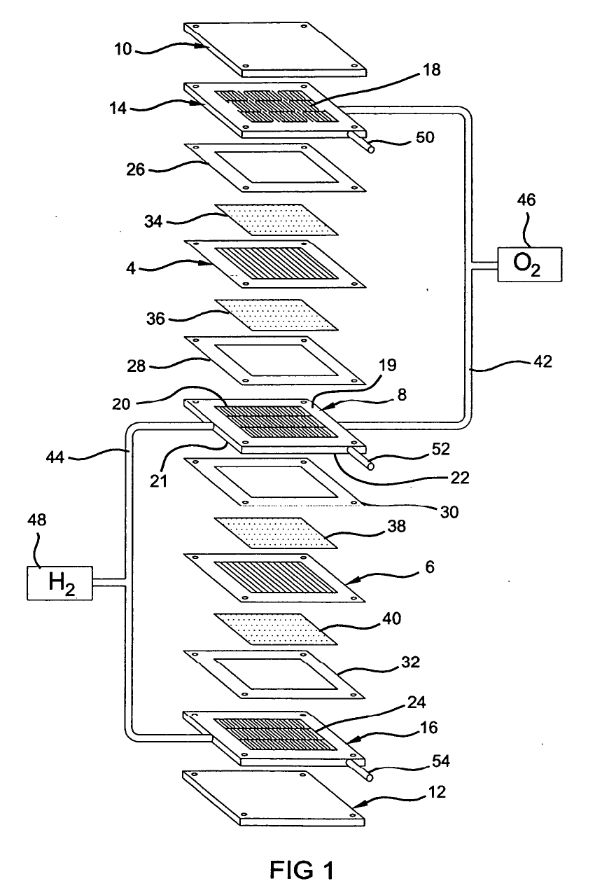

First, to better understand the present invention, a description of an exemplary fuel cell and stack are provided herein. FIG. 1 depicts two individual proton exchange membrane (PEM) fuel cells connected to form a stack having a pair of membrane-electrode-assemblies (MEAs) 4 and 6 separated from each other by an electrically conductive, liquid-cooled, bipolar separator plate 8. An individual fuel cell, which is not connected in series within a stack, has a separator plate 8 with a single electrically active side. In a stack, a preferred bipolar separator plate 8 typically has two electrically active sides 19, 21 within the stack, each active side 19, 21, respectively, facing a separate MEA 4, 6 with opposite charges that are separated, hence the so-called “bipolar” plate. As described herein, the fuel cell stack is described as having conductive bipolar plates; however, the present invention is equally applicable to conductive plates within a single fuel cell.

The MEAs 4 and 6, and bipolar plate 8, are stacked together between stainless steel clamping plates 10 and 12, and end contact elements 14 and 16. The end contact elements 14 and 16, as well as both working faces of the bipolar plate 8, contain a plurality of channels 18, 20, 22, and 24 for distributing fuel and oxidant gases (i.e., H₂ & O₂) to the MEAs 4 and 6. Nonconductive gaskets or seals 26, 28, 30, and 32 provide seals and electrical insulation between the several components of the fuel cell stack. Gas-permeable conductive diffusion media 34, 36, 38 and 40 press up against the electrode faces of the MEAs 4 and 6. The end contact elements 14 and 16 press up against the diffusion media 34 and 40 respectively, while the bipolar plate 8 presses up against the diffusion media 36 on the anode face of the MEA 4, and against diffusion media 38 on the cathode face of MEA 6.

Oxygen is supplied to the cathode side of the fuel cell stack from storage tank 46 via appropriate supply plumbing 42, while hydrogen is supplied to the anode side of the fuel cell from storage tank 48, via appropriate supply plumbing 44. Alternatively, air may be supplied to the cathode side from the ambient, and hydrogen to the anode from a methanol or gasoline reformer, or the like. Exhaust plumbing (not shown) for both the H₂ and O₂/air sides of the MEAs will also be provided. Additional plumbing 50, 52, 54 is provided for circulating coolant through the bipolar plate 8 and end plates 14 and 16.

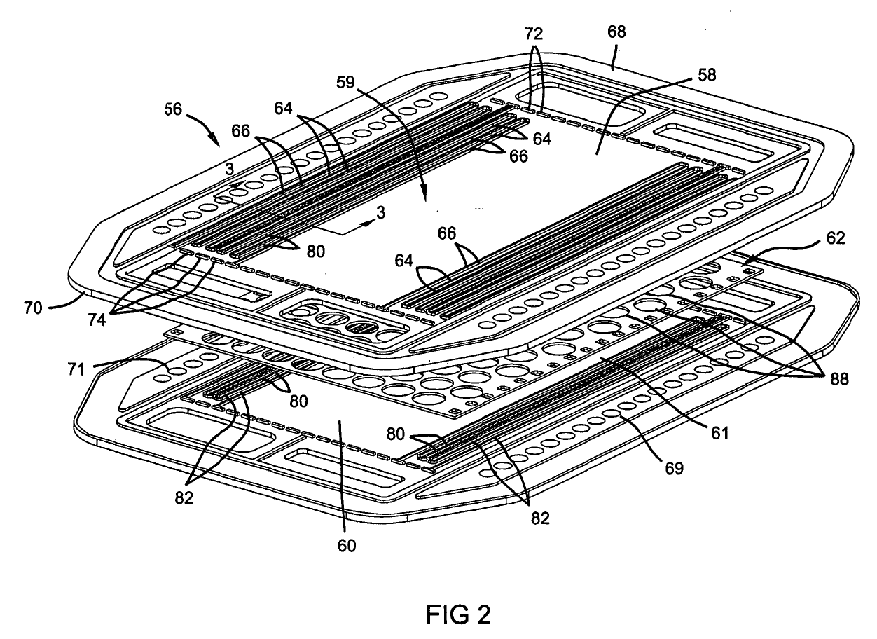

FIG. 2 is an isometric, exploded view of an exemplary bipolar plate 56 comprising a first exterior metal sheet 58, a second exterior metal sheet 60, and an interior spacer metal sheet 62 interjacent the first metal sheet 58 and the second metal sheet 60. The exterior metal sheets 58 and 60 are fabricated as thinly as possible (e.g., about 0.002-0.02 inches thick) and may be formed by stamping, by photo etching (i.e., through a photolithographic mask) or any other conventional process for shaping sheet metal.

The external sheet 58 has a first working face 59 on the outside thereof which confronts a membrane-electrode-assembly (not shown) and is formed so as to provide a plurality of lands 64 which define therebetween a plurality of grooves 66 known as a “flow field” through which the fuel cell's reactant gases (i.e., H₂ or O₂) flow in a tortuous path from an inlet side 68 of the bipolar plate to an outlet side 70 thereof. When the fuel cell is fully assembled, the lands 64 press against the diffusion media 36, 38 (FIG. 1) which, in turn, presses against the MEAs 4 and 6 respectively. For drafting simplicity, FIG. 2 depicts only two arrays of lands and grooves. In reality, the lands and grooves will cover the entire external faces of the metal sheets 58 and 60 that engage the diffusion media 36 and 38. The reactant gas is supplied to grooves 66 from a header or manifold groove 72 that lies along one side 68 of the fuel cell, and exits the grooves 66 via another header/manifold groove 74 that lies adjacent the opposite side 70 of the fuel cell.

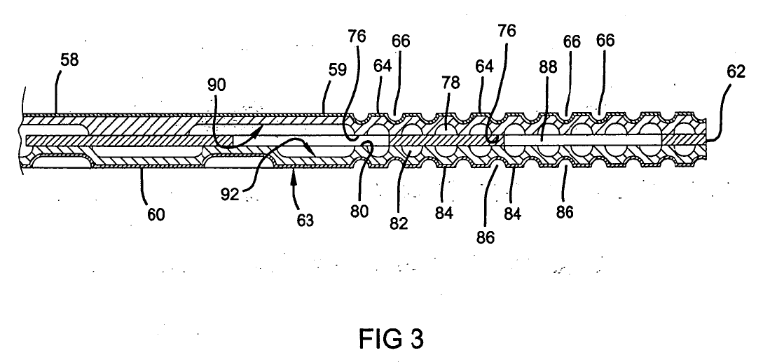

Metal sheet 60 is similar to sheet 58. The internal face 61 (i.e., coolant side) of sheet 60 is shown in FIG. 2. In this regard, there is depicted a plurality of ridges 80 defining therebetween a plurality of channels 82 through which coolant flows from one side 69 of the bipolar plate to the other 71. Like sheet 58 and as best shown in FIG. 3, which is a cross-sectional view along line 3-3′ of FIG. 2, the external side of the sheet 60 has a working face 63 having a plurality of lands 64 thereon defining a plurality of grooves 66 through which the reactant gases pass. An interior metal spacer sheet 62 is positioned interjacent the exterior sheets 58 and 60 and includes a plurality of apertures 88 therein to permit coolant to flow between the channels 82 in sheet 60 and the channels 78 in the sheet 58 thereby breaking laminar boundary layers and affording turbulence which enhances heat exchange with the inside faces 90 and 92 of the exterior sheets 58 and 60 respectively. As appreciated by one of skill in the art, a similar configuration can be used in a single fuel cell conductive plate, which is bounded internally by the MEA and externally by the end plates, where a coolant field may be used along the active face.

Selection of the material of construction for all elements in a fuel cell, and most particularly to bipolar plates, such as those in 56 (e.g., 58 and 60), includes weighing parameters such as overall density (mass and volume), electrical contact resistance of the substrate measured at the surface, bulk conductivity, and corrosion and oxidation resistance. For example, stainless steels are particularly desirable metals for use within a fuel cell, due to their relatively high bulk electrical conductivity and corrosion resistance provided by a dense passivation (i.e., metal oxide) layer at the surface. Stainless steel materials have relatively high strength, physical durability, adherence to polymer coatings, and are less expensive than many other conductive metal alternatives and can be formed into thin sheets that improve gravimetric efficiency. However, an extensive and thick oxide layer at the surface of a stainless steel element impermissibly increases electrical contact resistance of the substrate, which has previously prevented its independent use as an electrical contact element or current collector. Additionally, many other relatively lightweight metals are susceptible to corrosive attack (e.g., aluminum and titanium), as well as passivation by the formation of metal oxides at the surface.

In light of such corrosion sensitivity and similar propensity for oxidation, various protective coatings are preferred for protection of the underlying metal substrate 58,60. Some protective coatings have the potential to increase the electrical resistance of the surfaces (such as, 59,63) of the metal plate 58,60 to unacceptable levels or are very costly, such as with thick gold or platinum coatings. More economical alternatives, such as certain polymeric protective coatings, may peel or chip when subjected to electrochemical cell conditions for long durations, thereby exposing the underlying metal substrate to corrosive/oxidative attack. Thus, there is a trade-off between conductivity and corrosion protection. Previous protection methods include treating a conductive metal substrate to remove metal oxides, and then directly coating the treated surface with a protective polymeric polymer coating. One aspect of the present invention is an enhanced adhesion of the protective polymeric coating to the metal substrate (e.g., 58, 60) while retaining a desirable electrical contact resistance for the electrically conductive element 56.

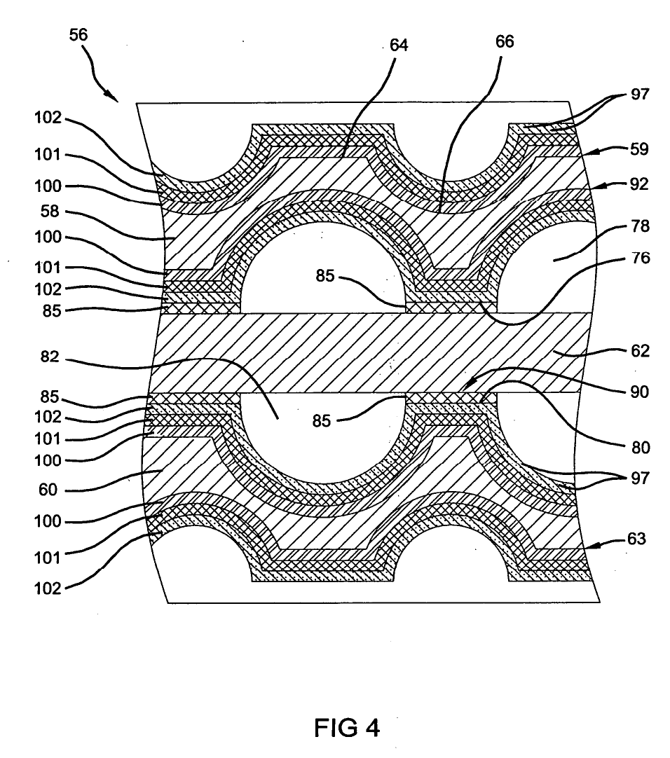

FIG. 4 is a magnified view of a cross-sectional view of FIG. 3 and shows the ridges 76 on the first sheet 58, and the ridges 80 on the second sheet 60 bonded (e.g., by brazement 85) to the spacer sheet 62. The present invention comprises a metal substrate forming the contact element sheets 58, 60 which comprises a metal susceptible to forming oxides in the presence of oxygen. In some preferred embodiments, the metal is also corrosion-susceptible. As used herein, “corrosion” refers to the unintentional and destructive attack or inactivation of a material, which generally occurs by an electrochemical dissolution. Thus, a corrosion-susceptible material, such as a metal, is subject to degradation and/or passivation within an operating fuel cell environment.

As shown in FIG. 4, a preferred embodiment of the present invention protects the working faces 59, 63 of the substrate metal of the first and second sheets 58, 60 by providing a sub-layer of an adhesion promoting coating 101 (also commonly referred to as tie-layers or coupling agents), which enhances adhesion of a prophylactic protective polymeric coating 102. A protective polymeric coating 102 protects the underlying substrate 58,60 and can be either oxidation-resistant, corrosion-resistant, or both, generally protecting the underlying substrate 58,60 from both additional oxidation and/or acid-attack upon exposure to the fuel-cell environment by increasing the adhesion of the prophylactic coating 102 to the metal substrate surfaces 59,60. Such an increased adhesion of the protective polymeric coating 102 to the substrates 59,60 is enhanced over an adhesion between a protective polymeric coating (similar to 102) and an underlying metal substrate (similar to 58,60) in the absence of an adhesion promoting sub-layer (configuration not shown).

As appreciated by one of skill in the art, the present invention is useful for increasing adhesion of any protective coatings 102 applied for protection on fuel cell elements that are exposed to fuel cell conditions. For example, as shown in FIG. 4, the inner surfaces 90,92 of each plate 58,60 which face coolant passages 78 of the bipolar plate 56, are also coated with a adhesion promoting coating 101 and a protective polymeric coating 102.

In preferred embodiments of the present invention, the surfaces (e.g., 59, 63, 90, 92) of the substrates 58,60 are susceptible to forming oxides in the presence of oxygen. Thus, in accordance with the present invention, in preferred embodiments, one or more metal oxide regions 100 are present along surfaces 59,63,90,92 over which the adhesion promoting coating 101 is applied. Such metal oxide layers may also be referred to as passivated regions 100, where “passivated” refers to the presence of metal oxides at the surface when compared with a metal not having metal oxides. The passivated regions 100 may comprise a variety of concentrations of oxides present along the surface (e.g., 59, 63, 90, 92), ranging from a low concentration (where most oxides have been removed) to a high concentration (forming a thick continuous layer). As used herein, the term “passivation layer” is synonymous with surface regions having metal oxides, and refers to the select regions 100 of the surface (e.g., 59,63,90,92) where metal oxides are present. Such a metal oxide passivation layer 100 may cover discrete regions or an entire continuous area of the substrate surface (e.g., 59,63,90,92).

Exposure to ambient air is generally sufficient to form passivated metal oxide regions 100 on a substrate susceptible to metal oxide formation. Also, intentional processing, such as anodization, forms select passivated regions 100 on a substrate susceptible to metal oxide formation. In a preferred embodiment of the present invention, the surface (such as, 59,63) of a substrate (such as, 58,60) has at least a small concentration of metal oxides present. It should be noted that metal oxides typically are much less electrochemically reactive than the base metal. However, a metal oxide layer facilitates better adhesion of a silane adhesion promoting sub-layer coating 101, and consequently, the overlying protective polymeric coating 102, as will be described in greater detail below. Enhanced adhesion minimizes potential flaws in the overlying protective polymeric coating, such as pinholes which expose underlying areas of uncoated metal. These pinholes arise as small, unprotected regions of the metallic surface, and have the potential to become growth sites for corrosion. Thus, in electrically conductive regions it is preferred to remove a sufficient amount of metal oxides to reduce electrical resistivity, while ensuring a sufficient amount of metal oxides to effectively adhere the adhesion promoting sub-layer coating 101. Alternatively, in some preferred embodiments, it is desirable to selectively remove the metal oxide region(s) 100 from the lands of the substrate (for example, from lands 64 of substrate 58 to decrease electrical resistance. As previously discussed, the lands (e.g., 64) form an electrically conductive path to other elements in the fuel cell stack, and thus surface resistance has a greater impact in the lands (e.g., 64) versus the grooves (e.g., 66).

Protective polymeric coatings 102 according to the present invention, are selected for their ability to withstand extreme fuel cell conditions and for their adhesion to select metal compositions, including metal oxide regions of the metal substrate (for the sake of brevity, the present discussion focuses on an exemplary half of the bipolar plate assembly, 56, namely the conductive element/substrate 58, which while used herein as an example, is not limiting to the applicability of the present invention). The present invention permits the use of an additional class of protective polymers for the protective polymeric coating 102 that have desirable conductivity, and cost, but previously lacked compatibility with and sufficient adhesion to metals. The present invention further provides improved performance for polymers that are presently used in protective polymeric coatings 102 by increasing adhesive properties to the substrate 58 surface 59 through use of the adhesion promoting coating 101.

Generally adhesion promoting coatings 101 are used to obtain improved adhesion between two distinct elements, (e.g., the substrate 58 and the polymeric coating 102). A “primer” generally refers to a coating applied to a surface prior to the application of another polymeric coating to improve the performance of the bond between the surface (e.g., 58) and the polymeric coating (e.g., 102). The adhesion promoter primer coating 101 is preferably a substance capable of holding materials together by surface attachment. The adhesion promoting coating 101 must be compatible with the substrate 58 and the protective polymeric coating 102 even when they have dissimilar properties. Adhesion promoting coatings 101 typically operate by Van der Waals attraction, hydrogen bonding and chemical bonding. Chemical covalent bonds are preferable because the covalent bonds have increased resistance to environmental changes and adverse conditions as compared to hydrogen bonding or Van der Waals attractions. In certain preferred embodiments, the adhesion promoting coating 101 utilizes covalent bonding between the surface 59 of the metal substrate 58 of the element 56 and the overlying protective polymeric coating 102 to improve endurance in the high pressure, heat and moisture conditions in a fuel cell.

In certain preferred embodiments of the present invention, the adhesion promoting coating 101 comprises a silicon containing polymer. Generally, such silicon adhesion promoting polymers are formed from a starting material composition comprising a silane compound that is treated to form the adhesion promoting polymer. Silanes are preferred starting materials for coupling agents, after treatment the adhesion promoting polymers link the interfaces of two dissimilar substrates due to their dual organic and inorganic properties. Treated silanes are also attractive because they are easy to apply as thin layers to a substrate. A silane generally is a polymeric compound of silicon and hydrogen having the general nominal formula expressed as a structural repeating unit, [SiₙH₂ₙ₊₂] where “n” is the average molecular ratio of silicon in the formula unit. Silanes are generally structurally analogous to alkanes or saturated hydrocarbons. Silanes further may have substituted constituent or side groups, known as “functionalized silanes.” Depending on the selected constituent groups present in the compound, silanes can be further classified into sub-groups of organo-functional silanes, amino-functional silanes, halosilanes, and silazanes. For example, halosilanes comprise chlorosilanes, which are silanes with a chlorine functional group, and fluorosilanes with a fluorine functional group. As appreciated by one of skill in the art, the variations in possible combinations of constituent groups useful for the present invention and corresponding to applicable classifications of silanes are extensive.

The most widely used silane adhesion promoter coupling agent coatings 101 are formed from the organo-functional silanes represented by the generally accepted nominal formula YRSiX₃, where X represents a hydrolysable group such as an alkoxy (for example, methoxy, ethoxy, phenoxy, acetoxy, or a halogen halide) and Y represents a non-hydrolysable functional organic group such as amino, amido, acrylate, hydroxyl, alkoxy, halo, mercapto, carboxy, acyl, vinyl, allyl, styryl, epoxy, isocyanato, glycidoxy, methacryloxy and azido and acryloxy. R is a small aliphatic linkage between the functional organic group and the silicon. R may comprise, for example, methyl, ethyl, propyl and butyl groups. With their organic and inorganic properties, organo-functional silanes are useful as adhesion promoting coatings 101 between the surface 59 of the metal substrate 58 and the polymeric protective coating 102.

Although not wishing to be bound to any particular theory by which the present invention operates it is believed that the hydrolysable organic portions of the organo-functional silanes in the adhesion promoting coating 101 interact and bond with metal oxides 100 present along the metal substrate surface 59 and the non-hydrolysable organic portions of the adhesion promoting coating 101 interacts and bonds with the polymeric coating 102.

Various silanes are also capable of crosslinking. The present invention contemplates use of self-crosslinking silanes, so long as sufficient organic groups remain available for interaction with the respective substrate 58 and/or polymeric coating 102. In preferred embodiments, some level of crosslinking occurs to enhance the physical integrity of the silane adhesion promoting coating 101. In certain preferred embodiments, the present invention contemplates addition of a stabilizer to a self-crosslinking silane polymer to control (generally by slowing) the rate of self-crosslinking. Further, it is preferred that the selected stabilizer does not leave a residue that potentially may contaminate the fuel cell during operations.

Preferred organo-functional silanes used to form adhesion promoting polymer coatings according to the present invention include the following non-limiting group: 6-azidosulfonylhexyltriethoxysilane; bis[(3-ethoxysilyl)propyl]ethylenediamine; N-[3-triethoxysilylpropyl]-4,5-dihydroimidazole; 3-aminopropyltriethoxysilane; 3-isocyanatopropyltriethoxysilane, diethoxyphosphatoethyltriethoxysilane; 5,6-epoxyhexyltriethoxysilane; bis-[3-(triethoxysilyl)propyl]amine; 3-aminopropylmethyldiethoxysilane; N-(2-aminoethyl)-3-aminopropyl-trimethoxysilane; N-(2-aminoethyl)-3-aminopropylmethyldimethoxysilane; bis-[3-(triethoxysilyl)propyl]disulfide; bis-[3-(triethoxysilyl)propyl]tetrasulfide; 3-mercaptopropyltriethoxysilane; aminopropylmethyldiethoxysilane; chloropropyltriethoxysilane; chloropropyltrimethoxysilane; glycidoxypropyltrimethoxysilane; mercaptopropyltrimethoxysilane; methacryloxypropyltrimethoxysilane; methyltriacetoxysilane (MTAS); methyltrimethoxysilane (MTMS); methyl tris-(butanone oxime) silane (MOS); methyl oximino silane (MOS); methyl tris-(methyl ethyl ketoximo) silane (MOS); tetraethoxysilane (TEOS); tetramethoxysilane (TMOS); vinyltriethoxysilane; vinyltrimethoxysilane; vinyl tris-(butanone oxime) silane (VOS); vinyl oximino silane (VOS); and vinyl tris-(methyl ethyl ketoximo) silane (VOS). In a preferred embodiment, the organo-functional silanes are 6-azidosulfonylexyltriethoxysilane; bis[(3-ethoxysilyl)propyl]ethylenediamine; N-[3-triethoxysilylpropyl]-4,5-dihydroimidazole; 3-amino-propyltriethoxysilane; diethoxyphophatoethyltriethoxysilane; 5,6-epoxyhexyltriethoxysilane; copolymers; and mixtures thereof. Particularly preferred silane polymers useful with the present invention are selected from the group consisting of 6-azidosulfonylhexyltriethoxysilane; bis[(3-ethoxysilyl)propyl]ethylenediamine; N-[3-triethoxysilylpropyl]-4,5-dihydroimidazole; 3-aminopropyltriethoxysilane; diethoxyphosphatoethyltriethoxysilane; 5,6-epoxyhexyltriethoxysilane, copolymers and mixtures thereof. A most preferred silane polymer comprises 3-aminopropyltriethoxysilane.

The hydrolyzable X constituent side group (i.e., alkoxy group) of the organo-functional silane is hydrolyzed to form a silanol where the hydrolyzable groups are replaced by hydroxyl groups via reaction with a hydrolyzing agent. When the adhesion promoting coating 101 is applied to the metal substrate 58, it is believed that these hydroxyl groups on the silanol are oriented towards the metal oxide regions 100 on the substrate surface 59, most likely due to Van der Waals attraction. As previously discussed, the following descriptions of the mechanism by which the present adhesion promoter coating 101 is believed to operate are not intended to be limiting as to how present invention operates.

The hydrolyzable functional groups on the functionalized silane (e.g., YRSiX₃) become the hydroxyl groups on the corresponding silanol (e.g., YRSi(OH)₃) which are available for reaction. As stated, the X group is an alkoxy group (i.e., methoxy). The alkoxy group is hydrolyzed into the corresponding alcohol of the X group (for example, methanol) and released from the silane thereby producing RSi(OH)₃ having three hydroxyl groups available for reacting with the metal oxides and three molecules of the X group of the corresponding alcohol. The newly formed alcohol can be volatilized and does not interfere with the coating preparation or application thereof.

A subsequent dehydration of the three available hydroxyl groups on the silanol molecules is believed to form two types of covalent bonds. The first is a self-bonding between silanol groups that results in the establishment of a silicon-oxygen backbone. While not intending to be limited by mechanism, it is believed that the condensation of the silanol molecules allows for the silicon of a first silanol to bond with the oxygen of a second silanol molecule. The silicon-oxygen backbone serves as the link between the newly formed metal-oxide bonds and the available R groups within the backbone. After the successive linking of silanol molecules to form the silicon-oxygen backbone, the second type of covalent bond is formed between the available hydroxyl groups on the silanol and the metal oxides on the metal substrate 58. The organic properties of the available R groups connect the silane adhesion promoting layer 101 with the protective polymeric coating 102 applied over the adhesion promoting coating 101, most likely through covalent bonds between the carboxyl groups on the coating resin chains thus providing a strong link between the protective polymeric coating 102 and the metal substrate 58.

Alternative preferred embodiments of the present invention relate to preferred methods of preparing the adhesion promoting coating 101. One such method according to the present invention comprises introducing a hydrolyzing agent into a solution comprising a functionalized silane and a solvent. In particularly preferred embodiments, the adhesion promoting solution comprises an organo-functional silane. The hydrolyzing agent serves to hydrolyze certain hydrolyzable functional groups (i.e., X) on the functionalized silane and the resultant hydrolysis promotes the interaction between the metal substrate 58 and the polymer coating 102. Preferred hydrolyzing agents comprise acids. Particularly preferred hydrolyzing agents comprise organic acids. It is preferred that the hydrolyzing agent comprises an organic acid. In a preferred embodiment, the organic acid is glacial acetic acid. Further, the adhesion promoting solutions of the present invention preferably comprise one or more solvents. One particularly preferred solvent is water. After addition of the hydrolyzing agent, it is preferred that the adhesion promoting coating solution is well mixed and has a pH of from about 3 to about 5 to promote the hydrolysis reaction. In certain preferred embodiments, the solution having the hydrolyzing acid agent is mixed for a short duration (e.g., about 10 minutes). As detailed above, the hydrolyzing agent hydrolyzes the hydrolyzable functional groups on the functionalized silane (e.g., YRSiX₃) into the corresponding silanol.

In another preferred embodiment, the adhesion promoting coating solution further comprises an optional wetting agent. Preferred wetting agents facilitate or enhance the application of the silane polymer to the substrate. Particularly preferred wetting agents leave the substrate free from wetting agent residue. Preferred wetting agents comprise an alcohol of low molecular weight including, by way of non-limiting example, ethanol, methanol, propanol, (e.g., isopropanol, 1-propanol, 1-butanol, etc.) and mixtures thereof. In one preferred embodiment, the wetting agent comprises ethanol. In other preferred embodiments, the wetting agent comprises an alkane. Preferably, the alkane has a carbon backbone having less than 15 carbon atoms. In a most preferred embodiment, the alkane comprises heptane. It is preferred that the backbone has less than 15 carbon atoms to facilitate volatilizing of the alkane in the solvent after application of the adhesion promoting coating solution 101 onto the substrate 58. The addition of the wetting agent makes the coating solution smoother and facilitates more even and easier application of the silane adhesion promoting coating solution onto the substrate. The non-polar alkane wetting agent provides better uniformity of the surface tension of the coating. With certain solvent polymer systems, the surface tension may be insufficient and the coating may pull away and form circular spots or regions lacking coating called “fish-eyes”.

The solution of adhesion promoting coating 101 may be applied to the substrate 58 surface 59 using known application methods which include gravure coating, reverse roller coating, doctor blade coating, dipping, painting, spraying, brushing, electrodeposition, vapor deposition, and the like. After application of the adhesion promoting coating solution 101 in liquid phase, it is preferred that the solvents and substantially all of the compounds dissolved therein are removed from the liquid layer, preferably by volatilization, thereby leaving a dry coating 101 along the regions of the surface 59 where the coating solution was applied. Thus, after applying the adhesion promoting solution 101 to the electrically conductive element 58 heat and/or reduced pressure are applied to volatize the solvents, wetting agents, and remaining compounds from the hydrolyzation process. Preferred methods of applying heat include placing the coated substrate in an oven and drying within a temperature range of about 85° C. to about 150° C. for 10 to 15 minutes. Any type of oven is suitable, including both non-vacuum and vacuum or aspiration ovens. Preferred ovens are non-vacuum ovens. In an embodiment where an aspirator is used, the element is dried under a drawn vacuum for a time sufficient to dry the solution and remove all solvents and additional components, generally from 30 minutes to 16 hours. Upon completion of the drying, a solid coating layer of the silane adhesion promoting polymer coating 101 is formed on the metal substrate 58.

In preferred embodiments, the dry adhesion promoting coating 101 has a thickness of less than 100 angstroms. In a particularly preferred embodiment, the silane adhesion promoting coating 101 has a thickness of between about one to a few monolayers. Such a thickness can be achieved by a single application of the adhesion promoter liquid solution 101 onto the substrate 58. Where a desired thickness for the adhesion promoter coating 101 is greater than a few monolayers, a thicker coating 101 is achieved by applying multiple layers of the coating solution in discrete sequential applications.

The one or more regions 100 of the substrate 58 having the adhesion promoting coating 101 are further overlaid with the protective polymer coating 102. The protective coatings 102 of the present invention are preferably both oxidation-resistant, corrosion-resistant, thereby protecting the underlying metal substrate 58 from exposure to corrosion agents. In certain preferred embodiments where the regions 100 form electrically conductive pathways in the fuel cell, it is also preferred that the protective coatings 101,102 overlying the surface 59 of the substrate 58 are electrically conductive and have a bulk resistivity of less than about 50 ohm-cm (Ω-cm). The contact resistance of the coating with the next element within the fuel cell should be less than about 50 milliOhm-cm².

In certain preferred embodiments, the protective coating 102 is electrically conductive and comprises a plurality of oxidation-resistant, acid-insoluble, conductive particles (i.e., less than about 50 microns) dispersed throughout an acid-resistant, oxidation-resistant polymer matrix, where the polymer matrix binds the particles together. It is preferred that the coating 102 contains sufficient conductive filler particles to produce a resistivity no greater than about 50 ohm-cm. Thinner protective polymeric coatings 102 (i.e., about 15-25 microns) are most preferred for minimizing the IR drop through the stack. For preferred embodiments of the present invention, the protective coating 102 has a thickness between about 5 microns and about 75 microns, preferably between 5 and 30 microns, depending on the composition, resistivity and integrity of the coating. Impervious protective coatings 102 are preferred for the present invention to protect the underlying metal substrate 58 surface from permeation of corrosive agents.

In accordance with the principles of the present invention, the conductive polymer coating 102 is applied directly over the dried silane polymer adhesion promoting coating 101 on the metal surface 59 and allowed to dry and cure thereon. The coating 102 may be applied in a variety of ways, and examples of such methods are described in detail in U.S. Pat. No. 6,372,376 to Fronk et al. and may include (1) electrophoretic deposition, (2) brushing, spraying or spreading, or (3) laminating. Electrophoretically deposited coatings are particularly advantageous because they can be quickly deposited in an automated process with little waste, and can be deposited substantially uniformly onto substrates 132 having complex and recessed surfaces like those used to form the reactant flow fields on the working surface(s) of the conductive elements. Electrophoretic deposition is a well-known process used to apply polymers to conductive substrates. When cross-linkable polymers are used, the suspension also preferably includes a catalyst for promoting the cross-linking. Cathodically deposited coatings are deposited by a process wherein positively charged polymer is deposited onto a negatively charged substrate. Cathodic epoxies, acrylics, urethanes and polyesters are useful with this method of depositing the coating. Other examples of suitable polymers include thermoset and thermoplastic resins, such as those disclosed in the U.S. Pat. No. 6,372,376 to Fronk, et al. and the references cited therein. Subsequent baking of the coated conductive element cures and densities the coating.

According to another preferred embodiment of the invention, the protective polymeric coating 102 is applied over the silane adhesion promoting coating 101 by spraying, brushing or spreading (e.g., with a doctor blade). In these embodiments, a precursor of the protective polymeric coating 102 is formed by dissolving the polymer in a suitable solvent, optionally mixing conductive filler particles 97 with the dissolved polymer (where the polymeric coating 102 is conductive) and applying it as wet slurry atop the silane adhesion promoting coating 101. The wet coating is then dried (i.e., the solvent removed) and cured as needed (e.g., for thermosets). The conductive particles 97 adhere to the surface 59 by means of the solvent-free polymer and its interaction with the adhesion promoting coating 101.

As shown in FIG. 5, in preferred embodiments, the protective coating 102 overlays a continuous region of the surface having metal oxides 100 of the substrate 58, for example, where the coated region 100 corresponds to the entire flow field comprising both lands 64 and grooves 66. The electrically conductive protective polymeric coating 102 having conductive particles 97 dispersed therein is applied across the continuous region 100 of the flow field and overlays the adhesion promoting coating 101.

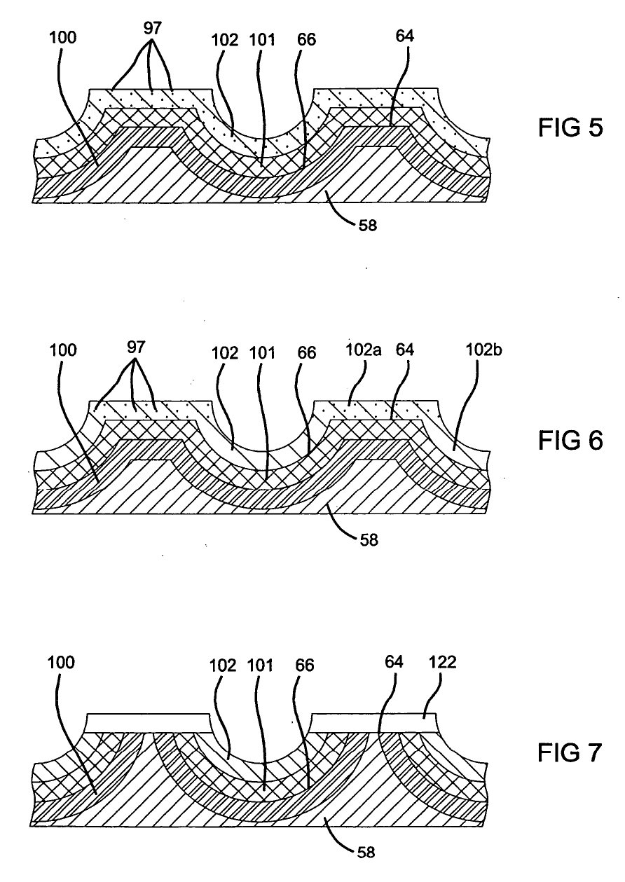

In alternate preferred embodiments, such as that shown in FIG. 6, the one or more coated regions 100 comprise the adhesion promoting coating sub-layer 101 and overlaid with the protective polymeric coating 102. In the embodiment shown, certain regions of the protective polymeric coatings 102a are electrically conductive, and thus also comprise a plurality of oxidation-resistant, acid-insoluble, conductive particles 97 (i.e., less than about 50 microns) that are dispersed along the electrically-conductive regions, i.e., the lands 66, to ensure electrical conductivity. Conductive particles 97 are present in the land 64 regions only (i.e., conductive regions of the protective coating 102a) where electrical conductivity is necessary, but are generally not present in the non-conductive groove regions 66. A polymer matrix is applied across the entire flow field of lands and grooves 64,66, such that the grooves 66 are coated with a non-conductive protective polymeric coating 102b (without conductive particles 97). Such selective application of conductive particles 97 can be achieved by sprinkling the conductive particles 97 over the lands 64 only (and not in the groove regions 66).

Masking is also desirable in manufacturing situations where different coating compositions are used on the lands 64 and the grooves 66, such as that shown in FIG. 6. In an alternative method of application according to the embodiment shown in FIG. 6, masking is particularly useful and can be used for applying a first non-conductive polymer coating 102 having no conductive particles 97 to select regions 120 corresponding to grooves 66. After the application of the first polymer coating 102, a first mask 106 can be removed and the newly coated regions 120 can be subsequently masked with a second mask (not shown). The second conductive polymer coating 102 having conductive particles 97 dispersed therein, can be applied to the exposed regions 120 that were previously masked with the first mask 106. As recognized by one of skill in the art, the compositions of the protective polymer coatings 102 may be different from one another, in the embodiment where the coatings differ over discrete regions.

In this manner, different compositions of polymeric coatings can be applied to different regions of the surface 59, for example, having a higher electrical conductivity may be applied to the lands 64 and a less electrically conductive polymeric coating 102 could be applied to the grooves 66, because only the lands 64 establish an electrically conductive path to other elements in a fuel cell assembly. Additionally, as shown in FIG. 7, other electrically conductive materials 122 could be applied to the lands 64, such as non-oxidizing metals, including for example, gold, platinum, rhodium, or mixtures and thereof. In the grooves 66, coated regions 100 comprise the adhesion promoting coating 101 overlaid with a non-conductive protective coating 102.

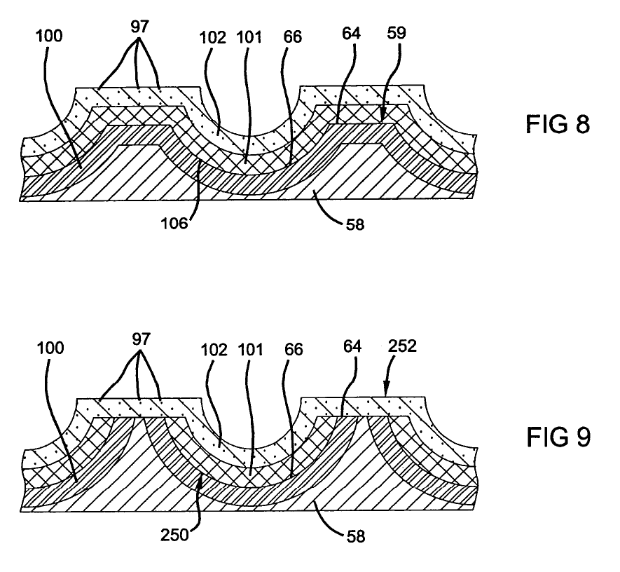

In preferred alternate embodiments such as that shown in FIG. 8, it is desirable to have the metal oxide coating 100 present only in the regions corresponding to grooves 66 of the flow field metal substrate working surface 59. To selectively remove metal oxides 100 from the substrate 58, the grooves 66 are covered with a masking material (not shown) before treating to remove the metal oxides therefrom (for example, by cathodic cleaning). After removing the select regions of metal oxides (leaving the metal oxides remaining on the grooves 66) the masking material is removed. The adhesion promoting coating 101 is applied both to the untreated grooves 66 and the treated lands 64. The coating process could also be adapted to coat the grooves 66 with a thicker coating of adhesion promoting coating 101, by performing coating many times while the masking material 106 remains on the lands 64, depending on the desired final thickness of the adhesion promoting coating 101 and/or the protective polymeric coating 101 in the grooves 66. A conductive protective polymeric coating 102 is applied over the lands 64 and grooves 66.

It should be noted that the present invention contemplates alternate preferred embodiments, such as that shown in FIG. 9, where one or more regions 250 comprise both the adhesion promoting coating 101 and the protective coating 102, as where other regions 252 may comprise only a protective coating 102 without the adhesion sub-layer 101. The regions 250 with the adhesion promoting coating 101 and the protective coating 102 ensure enhanced adhesion and protection, as where the single coated regions 252 have sufficient protection via the protective coating 102 alone. However, the single coated regions 252 have a reduced electrical resistance by eliminating a potentially resistant additional sub-layer, namely the adhesion promoting coating 101. The single coated regions 252 generally correspond to electrically conductive regions of the surface 59, here corresponding to the lands 64.

Preferably, the conductive filler particles 97 for the electrically conductive protective polymer coating 102 are selected from the group consisting of gold, platinum, graphite, carbon, nickel, conductive metal borides, nitrides and carbides (e.g., titanium nitride, titanium carbide, titanium diboride), titanium alloyed with chromium and/or nickel, palladium, niobium, rhodium, rare earth metals, and other noble metals. Most preferably, the particles comprise carbon or graphite (i.e., hexagonally crystallized carbon). The particles 97 comprise varying weight percentages of the protective coating 102 depending on the density and conductivity of the particles (i.e., particles having a high conductivity and low density can be used in lower weight percentages). Carbon/graphite containing coatings 102 will typically contain 25 percent by weight carbon/graphite particles.

The polymer matrix of the protective coatings 102 of the present invention preferably comprise any water-insoluble polymer that can be formed into a thin adherent film and that can withstand the hostile oxidative and acidic environment of the fuel cell. Further, it is preferred that the selected polymer is compatible with the adhesion promoting coating 101. Hence, such polymers, as epoxies, silicones, polyamide-imides, polyether-imides, polyphenols (phenolics), fluoro-elastomers (e.g., polyvinylidene fluoride), polyesters, phenoxy-phenolics, epoxide-phenolics, acrylics, and urethanes, inter alia are seen to be useful with the present invention. Cross-linked polymers are preferred for producing impermeable protective coatings 102.

A preferred polymer useful with this embodiment comprises a polyamide-imide thermosetting polymer. It is preferred that the polyamide-imide is dissolved in a compatible solvent vehicle for application, as recognized by one of skill in the art. For example, in one preferred embodiment, the polyamide-imide is dissolved in a solvent comprising a mixture of N-methylpyrrolidone, propylene glycol and methyl ether acetate. To this solution is added about 21% to about 23% by weight of a mixture of graphite and carbon black particles wherein the graphite particles range in size from about 5 microns to about 20 microns and the carbon black particles range in size from about 0.5 micron to about 1.5 microns, with the smaller carbon black particles serving to fill the voids between the larger graphite particles and thereby increase the conductivity of the coating compared to that of all-graphite coatings.

In preferred embodiments of this invention, the protective polymer coating 102 is applied over the silane adhesion promoting coating 101 substrate 58, dried and cured. It is preferred that the polymer coating 102 is coated to provide a coating thickness of about 15-30 microns (preferably about 17 microns), and has a carbon-graphite content of about 38% by weight. It may be cured slowly at low temperatures (i.e., <200° C.), or more quickly in a two-step process wherein the solvent is first removed by heating for ten minutes at about 150° C. to 175° C. (i.e., dried) followed by higher temperature heating (250° C. to 400° C.) for curing, typically for a duration of between approximately about 30 seconds to about 15 minutes, with the time ultimately being dependent on the temperature used to cure each specific polymer.

As previously discussed, metal oxides significantly increase electrical resistance of metal substrates, and in preferred embodiments, a large portion of such metal oxides are removed from metal substrate surfaces to be coated with polymers. Metal oxides can be removed by cathodic cleaning, for example, where electrical current (e.g., a current density of between about 10-20 mA/cm²) is impressed onto the conductive substrate which is in contact with an electrolyte to facilitate the generation of gas bubbles at the surface, such as cathodic cleaning described in ASTM B254 7.4.1, for example. Such cathodic cleaning generally takes a minimum processing time of at least 10 minutes (typically longer) to effectively clean the metal substrate. Other methods of removing metal oxides are those known by one of skill in the art, and include, for example, pickle liquor treatment, such as with sulfuric or hydrofluoric acid, mechanical abrasion, and the like. Any method of removing oxides known to one of skill in the art that does not detrimentally impact the physical properties of the metal is contemplated for use with the present invention.

In certain preferred alternate embodiments of the present invention, the metal substrate is pre-cleaned prior to applying the adhesion promoting solution. Such cleaning typically serves to remove any loosely adhered contaminants, such as oils, grease, waxy solids, particles (including metallic particles, carbon particles, dust, and dirt), silica, scale, and mixtures thereof. Many contaminants are added during the manufacturing of the metal material, and may also accumulate on the surface during transport or storage. Thus, pre-cleaning is preferred in circumstances where the metal substrate provided for processing is soiled with contaminants. Pre-cleaning may entail mechanical abrasion; cleaning with traditional alkaline cleaners, surfactants, mild acid washes; or ultrasonic cleaning. The choice of the appropriate cleaning process or sequence of cleaning processes is selected based upon both the nature of the contaminant and the metal.

### EXAMPLE 1

An adhesion promoting coating solution is made by adding a functionalized silane, 3-aminopropyltriethoxyilane (1 gram obtained from Gelest), to a solvent of de-ionized water (4 grams). The solution is then magnetically stirred for 4 hours. A hydrolyzing agent of glacial acetic acid (0.3 grams) is then added and stirring continues for 10 minutes. A first wetting agent, ethanol, is added at 74.7 grams, followed by a second alkane wetting agent, heptane, at 20 grams. A bipolar plate is pre-treated by cathodic cleaning to remove substantially all metal oxides from a surface to be treated. The pre-treated plate is then immersed in a Pyrex brand glass baking dish containing the coating solution. The treated silane coated bipolar plate is removed from the solution and then heated in a vacuum oven and dried at 85° C. under reduced aspirator suctiori for between 30 minutes and 16 hours. The dried silicon adhesion promoting polymer coated plate is then spray coated with a conductive polyamide-imide protective coating. The protective coating polymer is cured by heat application in a two step temperature cure whereby the temperature of the first cure step is to evaporate the low boiling temperature solvent and the second temperature is to evaporate off the higher boiling temperature solvent and to drive the crosslinking reaction of the polymer phase of the coating. For most applications, these two temperatures are around 150° C. for the first cure step and around 300° C. for the second cure step, with a dwell time at each temperature of around 10-15 minutes. After curing, the adhesion of the coating on the treated silane/adhesion promoting polymer coated bipolar plate was found to be superior to that of a bipolar plate that was not coated with a silane adhesion promoter coating, as determined by a Scotch tape adhesion test.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electrically conductive element for an electrochemical cell comprising:
an electrically conductive substrate having a surface susceptible to corrosion;
an adhesion promoting coating overlying one or more regions of said surface, wherein said coating comprises a polymer comprising silicon; and
a corrosion resistant protective polymeric coating overlying said adhesion promoting coating of said one or more regions.

2. The electrically conductive element of claim 1, wherein said electrically conductive substrate comprises at least one of: titanium; stainless steel; nickel; magnesium; aluminum; alloys and mixtures thereof.

3. The electrically conductive element of claim 1, wherein said electrically conductive substrate comprises a metal susceptible to forming oxides in the presence of oxygen and said surface of said substrate is treated to remove at least a portion of said oxides from said surface.

4. The electrically conductive element of claim 1, wherein said polymer comprising silicon is formed from a starting composition comprising at least one of: organo-functional silanes; amino-functional silanes; chlorosilanes; fluorosilanes; silazanes; and co-polymers thereof and mixtures thereof.

5. The electrically conductive element of claim 4, wherein said polymer comprising silicon is formed from a starting composition comprising an organo-functional silane.

6. The electrically conductive element of claim 1, wherein said polymer comprising silicon is formed from a starting composition comprising at least one of: 6-azidosulfonylhexyltriethoxysilane; bis[(3-ethoxysilyl)propyl]ethylenediamine; N-[3-triethoxysilylpropyl]-4,5-dihydroimidazole; 3-aminopropyltriethoxysilane; diethoxyphosphatoethyltriethoxysilane; 5,6-epoxyhexyltriethoxysilane; bis-[3-(triethoxysilyl)propyl]amine; 3-aminopropylmethyldiethoxysilane; N-(2-aminoethyl)-3-aminopropyl-trimethoxysilane; N-(2-aminoethyl)-3-aminopropylmethyldimethoxysilane; bis-[3-(triethoxysilyl)propyl]disulfide; bis-[3-(triethoxysilyl)propyl]tetrasulfide; 3-mercaptopropyltriethoxysilane; aminopropylmethyldiethoxysilane; chloropropyltriethoxysilane; chloropropyltrimethoxysilane; glycidoxypropyltrimethoxysilane; 3-isocyanatopropyltrimethoxysilane, 3-isocyanatopropyltriethoxysilane, mercaptopropyltrimethoxysilane; methacryloxypropyltrimethoxysilane; methyltriacetoxysilane (MTAS); methyltrimethoxysilane (MTMS); methyl tris-(butanone oxime) silane (MOS); methyl oximino silane (MOS); methyl tris-(methyl ethyl ketoximo) silane (MOS); tetraethoxysilane (TEOS); tetramethoxysilane (TMOS); vinyltriethoxysilane; vinyltrimethoxysilane; vinyl tris-(butanone oxime) silane (VOS); vinyl oximino silane (VOS); vinyl tris-(methyl ethyl ketoximo) silane (VOS); and copolymers thereof and mixtures thereof.

7. The electrically conductive element of claim 1, wherein said polymer comprising silicon is formed from a starting composition comprising at least one of: 6-azidosulfonylhexyltriethoxysilane; bis[(3-ethoxysilyl)propyl]ethylenediamine; N-[3-triethoxysilylpropyl]-4,5-dihydroimidazole; 3-aminopropyltriethoxysilane; diethoxyphosphatoethyltriethoxysilane; and 5,6-epoxyhexyltriethoxysilane; and copolymers thereof and mixtures thereof.

8. The electrically conductive element of claim 1, wherein said polymer comprising silicon is formed from a starting composition comprising 3-aminopropyltriethoxy silane.

9. The electrically conductive element of claim 1, wherein said adhesion promoting coating overlies substantially the entire surface of said substrate.

10. The electrically conductive element of claim 1, wherein said adhesion promoting coating has a thickness of less than about 100 angstroms.

11. The electrically conductive element of claim 1, wherein said protective polymeric coating is electrically conductive and comprises a polymeric matrix comprising an organic polymer and a plurality of conductive particles.

12. The electrically conductive element of claim 1, wherein said protective polymeric coating comprises at least one of: epoxies; silicones; polyamide-imides; polyether-imides; polyphenols; phenolics, polyvinylidene fluoride; polyesters; phenoxy-phenolics; epoxide-phenolics; acrylics; urethanes; and mixtures thereof.

13. The electrically conductive element of claim 1, wherein said electrically conductive substrate comprises metal and said corrosion includes metal oxides, and said adhesion promoting coating improves adhesion between said protective polymeric coating and said substrate as compared to adhesion in the absence of said adhesion promoting coating.

14. A method of making an element for a fuel cell, comprising:
applying an adhesion promoting coating comprising a polymer comprising silicon to one or more regions of a surface of a substrate; and
overlaying said adhesion promoting coating with a corrosion resistant protective polymeric coating at said one or more regions.

15. The method of claim 14, wherein said applying of said adhesion promoting coating is conducted by at least one of: submerging; spraying; and doctor blading.

16. The method of claim 14, wherein said applied adhesion promoting coating has a thickness of less than about 100 angstroms.

17. The method of claim 14, wherein said substrate surface is susceptible to forming oxides in the presence of oxygen and prior to said applying, treating said surface to partially remove said oxides by at least one of: cathodic cleaning; mechanical abrasion; applying alkaline cleansers; applying acidic agents; and applying pickle liquors.

18. The method of claim 14, wherein prior to said applying of said adhesion promoting coating, cleaning said substrate surface to remove any loosely adhered contaminants therefrom.

19. The method of claim 14, further comprising after said overlaying, applying heat to promote curing of said substrate having said adhesion promoting coating and said corrosion resistant protective polymer coating applied.

20. A method of making an element for a fuel cell, comprising:
mixing a hydrolyzation agent into an adhesion promoting solution comprising a functionalized silane and a solvent comprising water, wherein said hydrolyzation agent hydrolyzes at least a part of said functionalized silane to form a polymer comprising silicon;
applying said mixed adhesion promoting solution to one or more regions of a surface of a metal substrate, wherein said solvent and said hydrolyzation agent are removed from said solution, thereby leaving said polymer comprising silicon in a substantially solid phase overlying said metal substrate to form an adhesion promoting coating; and
overlaying said adhesion promoting coating with a corrosion resistant protective polymeric coating at said one or more regions.

21. The method of claim 20, wherein said functionalized silane undergoes self-crosslinking and said solution further comprises a stabilizing agent for slowing said self-crosslinking.

22. The method of claim 20, wherein said solution further comprises a wetting agent comprising at least one of an alcohol, an alkane, and mixtures thereof.

23. The method of claim 20, wherein said solution comprises at least one of ethanol, methanol, isopropyl alcohol, 1-propanol, heptane, and mixtures thereof.

24. The method of claim 20, wherein after said mixing, said solution has a pH of less than about 5.

25. The method of claim 20, wherein said solution further comprises a hydrolyzation agent comprising at least one of: acetic acid; formic acid; propionic acid; butyric acid; glacial acetic acid; and mixtures thereof.

26. The method of claim 20, wherein said functionalized silane comprises at least one of: organo-functional silanes; amino-functional silanes; chlorosilanes; fluorosilanes; silazanes; and co-polymers thereof and mixtures thereof.

27. The method of claim 20, wherein said functionalized silane comprises at least one of: 6-azidosulfonylhexyltriethoxysilane; bis[(3-ethoxysilyl)propyl]ethylenediamine; N-3-triethoxysilylpropyl]-4,5-dihydroimidazole; 3-aminopropyltriethoxysilane; diethoxyphosphatoethyltriethoxysilane; 5,6-epoxyhexyltriethoxysilane; bis-[3-(triethoxysilyl)propyl]amine; 3-aminopropylmethyldiethoxysilane; N-(2-aminoethyl)-3-aminopropyl-trimethoxysilane; N-(2-aminoethyl)-3-aminopropylmethyldimethoxysilane; bis-[3-(triethoxysilyl)propyl]disulfide; bis-[3-(triethoxysilyl)propyl]tetrasulfide; 3-mercaptopropyltriethoxysilane; aminopropylmethyldiethoxysilane; chloropropyltriethoxysilane; chloropropyltrimethoxysilane; 3-glycidoxypropyltrimethoxysilane; 3-glycidoxypropyldimethylethoxysilane; 3-glycidoxypropyldimethylmethoxysilane; 3-isocyanatopropyltrimethoxysilane; 3-isocyanatopropyltriethoxysilane, mercaptopropyltrimethoxysilane; methacryloxypropyltrimethoxysilane; methyltriacetoxysilane (MTAS); methyltrimethoxysilane (MTMS); methyl tris-(butanone oxime) silane (MOS); methyl oximino silane (MOS); methyl tris-(methyl ethyl ketoximo) silane (MOS); tetraethoxysilane (TEOS); tetramethoxysilane (TMOS); vinyltriethoxysilane; vinyltrimethoxysilane; vinyl tris-(butanone oxime) silane (VOS); vinyl oximino silane (VOS); vinyl tris-(methyl ethyl ketoximo) silane (VOS); and copolymers thereof and mixtures thereof.

28. The method of claim 20, wherein said functionalized silane comprises 3-aminopropyltriethoxy silane.
